(19) United States
(12) Patent Application Publication
(10) Pub. No.: US 2022/0339901 A1
(43) Pub. Date: Oct. 27, 2022

(54) METHOD OF MANUFACTURING A NOVEL PAPER BAG AND BAGS THEREFOR

(71) Applicant: Craig Evans, Frankenmuth, MI (US)

(72) Inventor: Craig Evans, Frankenmuth, MI (US)

(21) Appl. No.: 17/240,249

(22) Filed: Apr. 26, 2021

(51) Int. Cl. B31B 70/26; B65D 33/18; B65D 33/26; B65D 33/08; B31B 70/62; B31B 70/60; B31B 70/68

(52) U.S. Cl. CPC B31B 70/26; B65D 33/18; B65D 33/26; B65D 33/08; B31B 70/62; B31B 70/61; B31B 70/68; B31B 2150/001

(57) ABSTRACT

What is disclosed is a method of constructing a pager bag having looped attachments wherein the method comprises forming a predetermined construction from paper bag paper.

### BACKGROUND OF THE INVENTION

Applicant is aware of U.S. Pat. No. 2,079,592 to Battin, that issued on May 11, 1937 dealing with a garbage receptacle that is collapsible against a frame.

### THE INVENTION

Thus, what is disclosed is a method of constructing a pager bag wherein the method comprises forming a predetermined construction from paper bag paper that has four distinct sections, a leading edge, a following edge, two truncated flaps on a first end, two truncated flaps on a second end and two square flaps alternating with two truncated flaps on the first end and the second end.

The four distinct sections are folded over such that a leading edge and a following edge overlap. Thereafter, attaching the edges to each other.

Both square flaps are folded over on a first end of the construction and attached to each other at a common overlap. Two truncated flaps of the construction are folded over on a first end of the construction onto the folded square flaps and attaching the truncated flaps to the folded square flaps.

Two square flaps on the second end of the construction, near a top outside surface thereof, are formed into a small, looped attachment to the construction.

Also contemplated within the scope of this invention are bags manufactured from this process.

### BRIEF DESCRIPTION OF THE DRAWINGS

FIG. 1 is a full view of a pattern 1 that is used in the method of this invention.

FIG. 2 is the pattern of FIG. 1 showing additional handles for the bag.

FIG. 3 is a back view of a bag of this invention showing the looped attachment without any extra construction material.

FIG. 4 is a full back view of a bag of this invention showing the looped attachment with extra construction material.

FIG. 5 is a full front view of a bag of this invention showing the closure area for forming the bag.

FIG. 6 is a full bottom view of a bag of this invention.

FIG. 7 is full front view of a bag of this invention showing the overlapped closure for forming the bag.

FIG. 8 is a full side view o a top portion of a bag of this invention.

### DETAILED DESCRIPTION OF THE DRAWINGS

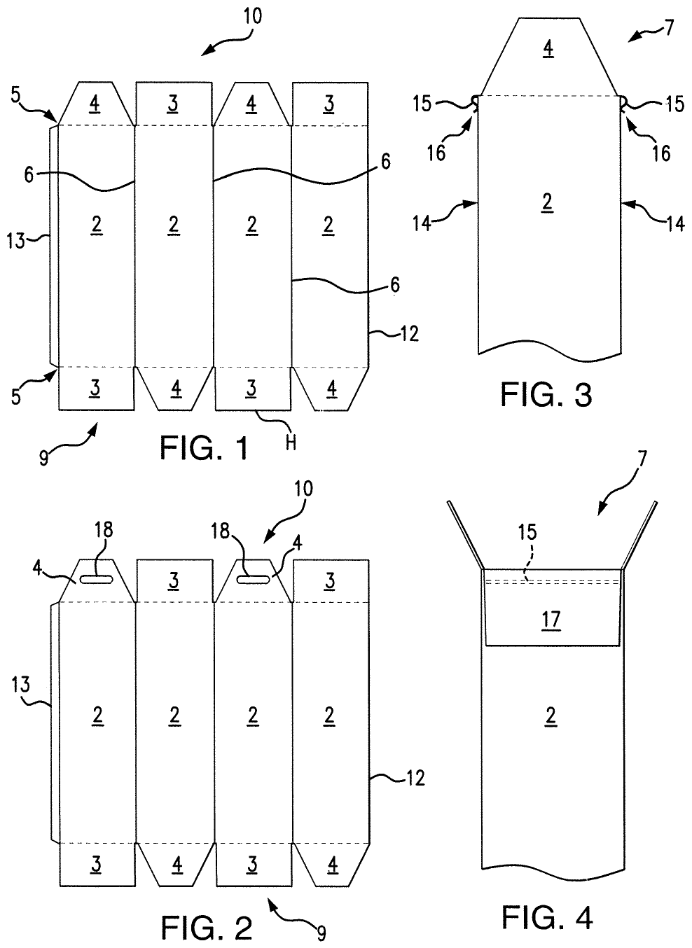

Turning to FIG. 1 there is shown a pattern for manufacturing a bag by this method. Shown are four, essentially equal in area segments 2 having alternate end pieces. That is, square ends 3 and truncated ends 4, along with crease and bend lines 5 and crease and bend lines 6.

The construction is facilitated by forming the bag 7 first by bending the segments 2 along the crease lines 6 such that they form a hollow shell. The end designated 9 in FIGS. 1 and 2 is the bottom end, or the first end of the bag 7, and in FIGS. 1 and 2 is the designated top 10, or the second end. The overlap of the segments 2 are attached as shown in FIG. 7 where the edge 12 (shown in phantom) is overlapped by the edge 13.

In the first end 9, the square flaps 3 are first folded inwardly toward each other and attached together near their leading edges 11. These edges overlap and are thus fastened together at this point.

The truncated flaps 4 are then folded over top of the square flaps 3 and attached to the square flaps 3 to form a secure bottom or first end to the bag 7 (See FIG. 6). For purposes of this invention, the fastening of the bag 7 can be by any of the methods generally used, such as self-sticking adhesive, adhesive tape, glue, staples, tape, or the like.

The second end 10 looped attachments 15 (shown in FIG. 4 in phantom and in FIG. 3) are formed by bending each square flap 3 at the second end 10 back over the outside 14 of segment 2 to form a loop. In FIG. 3, the looped attachment 15 is shown without additional construction material at 16 and in FIG. 4 with additional construction material 17.

The bag 7 is now ready for use. “Small” for purposes of this invention means that Rods or poles (not shown because not part of the invention) can be inserted into the looped attachments 15 and the bag 7 can then be supported on a framework attached to a lawn tractor or the like. The size of the rods or poles is not critical, as long as they are stout enough to support a full bag of lawn debris. Preferred for this invention are rods of plastic or metal having a diameter of from ½ inch to 1 inch.

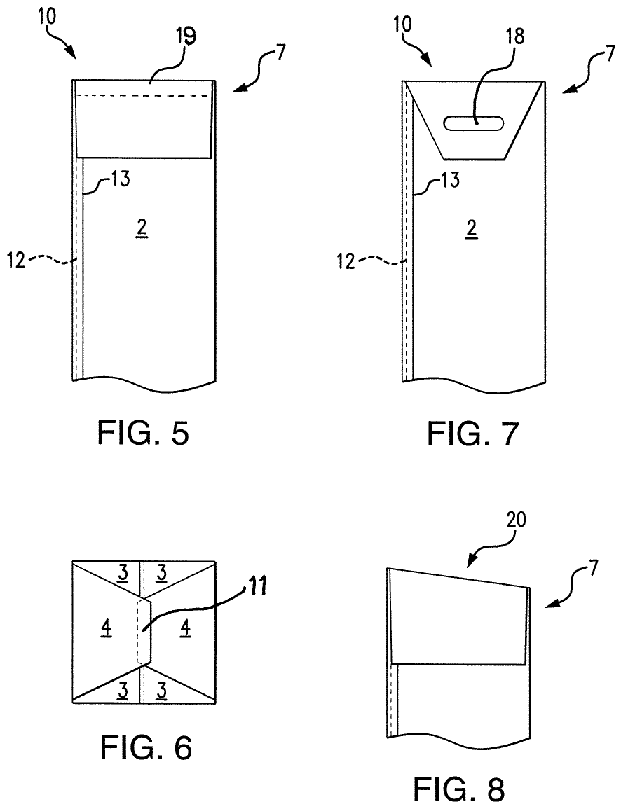

When the bag 7 needs to be removed from the support on the tractor and moved to a salvage removal point, then the truncated flaps 4 are folded won over the top 10 of the bag 7 and then the square flaps 3 are laid over top of the truncated flaps 4. In the event that the bag 7 is equipped with self-stick adhesive 19 (FIG. 5) at the top end 10, and the bag 7 is equipped with openings 18 (FIGS. 2 and 7) to form a handle, then the bag 7 can be easily carried.

The bag 7 is constructed out of paper bag paper, such as Kraft paper.

Also contemplated within the scope of this invention is a bag 7 whose top edges 20 (See FIG. 8) is inclined. Such a bag when fitted onto certain lawn tractors will automatically be leveled by the frame support on the tractor.

What is claimed is:

1. A method of constructing a pager bag, said method comprising:
A. forming a predetermined construction from paper bag paper that has four distinct sections, a leading edge, a following edge, two truncated flaps on a first end and two truncated flaps on a second end and two square flaps alternating with said two truncated flaps on said first end and said second end;
B. folding said four distinct sections such that said leading edge and said following edge overlap, and, attaching said edges to each other;
C. folding both square flaps on a first end of said construction and attaching them to each other at a common overlap;
D. folding two truncated flaps of said construction on a first end of said construction onto said folded square flaps and attach said truncated flaps to said folded square flaps;
E. folding over two square flaps on said second end of said construction near a top outside surface thereof to form a small, looped attachment to said construction.

2. The method as claimed in claim 1 wherein openings are formed in said second end square flaps, wherein said openings in each second end square flap aligns with the other said opening.

3. The method as claimed in claim 1 wherein in step D. the looped attachment does not have any construction beyond said looped attachment.

4. The method as claimed in claim 1 wherein in step D. the looped attachment does have construction beyond said looped attachment.

5. The method as claimed in claim 1 wherein top edges of said square flaps have a self-stick adhesive applied to them.

6. The method as claimed in claim 1 wherein the constructed paper bag is configured having 18 inches to 28 inches in open top area and from 24 to 40 inches in length from a first end to a second end.

7. The method as claimed in claim 1 wherein the means of attachment is self-stick adhesive.

8. The method as claimed in claim 1 wherein the means of attachment is adhesive tape.

9. The method as claimed in claim 1 wherein the means of attachment is staples.

10. The method as claimed in claim 1 wherein the means of attachment is glue.

11. A paper bag constructed by the method as claimed in claim 1.
